(19) United States
(12) Patent Application Publication
(10) Pub. No.: US 2015/0352655 A1
(43) Pub. Date: Dec. 10, 2015

(54) CONTROL SYSTEM WITH PRESSURE DIFFERENTIAL MODULE OPERATING WITH PRESSURE SENSING AND AIR SPEED SENSORS

(71) Applicant: Safehouse Habitats (Scotland) Limited, Dundee (GB)

(72) Inventors: Philip Graham WATTERS, Falkirk (GB); Gordon Iain PRIESTLY, Stirling (GB)

(21) Appl. No.: 14/378,709

(22) PCT Filed: Feb. 14, 2013
(86) PCT No.: PCT/GB2013/050342

§ 371 Date: Aug. 14, 2014

(30) Foreign Application Priority Data
Feb. 15, 2012 (GB) 1207686.5

(51) Int. Cl. B23K 9/095; G05D 16/20; G05B 9/02

(52) U.S. Cl. CPC B23K 9/0953; G05B 9/02; G05D 16/20

(57) ABSTRACT

Discloses is a control system (10) for use with a hot work habitat (12) in which an overpressure is to be established, and a method of use of the control system (10). The control system (10) comprises a shutdown module (20) for stopping the operation of apparatus for performing hot work within the habitat (12) responsive to a received alarm signal, when the control system (10) is used with a hot work habitat (12). Pressure sensing apparatus (26) for measurement of static pressure difference between the interior of a habitat (12) and external to a habitat (12), and at least one air speed sensor (38) for measurement of air speed outside of a habitat (12) are in communication with a pressure differential module (26). The pressure sensing module (26) is operable to calculate a threshold air speed value above which the static pressure difference is less than a predetermined pressure difference, and configured to send an alarm signal to the shutdown module (20) if an air speed value is detected above the threshold air speed value. Accordingly, the system (10) detects air movement with the potential to generate a dynamic pressure sufficient to cause a loss of containment in the habitat (12), and causes the hot work apparatus to be shut down.

### INTRODUCTION

The present invention relates to a monitoring and control system for use in the operation of a hot work enclosure.

### BACKGROUND

Enclosures, also referred to as habitats, are commonly used for undertaking hot work such as welding, grinding and heat treatment in an environment where flammable gases may be present, for example in an oil or gas production environment. A hot work enclosure comprises an enclosed structure which is built around the item of work on which hot work is to be undertaken and a positive air pressure is then applied inside the enclosure so as to prevent the ingress of flammable gases and to provide a safe environment for undertaking hot work.

The hazardous environment in which these enclosures are being used has triggered the development of a number of control systems enabling the systematic shutdown of the enclosure and hot work equipment upon detection of dangerous gas inside or in the vicinity of the habitat.

U.S. Pat. No. 7,091,848, Albarado et al, describes an enclosure system having one or more hot work enclosures capable of being simultaneously and independently controlled and monitored by a single control and monitoring system. Each enclosure has a blower in communication with a blower control, a gas detection monitor located at the intake of the blower and a differential pressure monitor for monitoring the pressure within the enclosure relative to the pressure outside of the enclosure.

U.S. Pat. No. 7,397,361, Paulsen, describes a safety system in connection with the operation of a habitat comprising a shut-down central to which is connected a number of detectors placed in or adjacent to the habitat, and that can register parameters such as gases, temperatures, changes in temperature, and also pressure adjacent to or inside the habitat. In this safety system, the shut-down central is arranged to shutdown operation of the heat generating equipment when irregularities arise in the operation of the habitat.

When monitoring the overpressure of the habitat, the current control systems in place only take into consideration the static pressure differential measured between the inside and the outside of the habitat and incorporate a minimum pressure differential for safe operation, usually around 50 Pa. This approach ignores the effect of hydraulic head and more importantly dynamic pressure caused by the wind outside the habitat.

The connection areas between panels constitute leakage zones, allowing air to circulate between the inside and the outside of the habitat. Applying Bernouilli's principle, it can be shown that a wind speed of only 16 knots (30 km/hour) correlates to a dynamic pressure sufficient to overcome a (static) overpressure of 50 Pa and can therefore potentially compromise containment of an enclosure operating with an overpressure of 50 Pa. Gusts of wind, for example on offshore oil and gas extraction or explorations rigs, can therefore lead to a loss of containment.

Furthermore, a habitat is typically a modular structure made of flexible panels connected together to form walls, ceiling and floor. Therefore, gusts of wind can in some cases exert a transient pressure on the enclosure's panels, leading to a sudden deformation of the habitat structure. Deformation of the structure (and subsequent recovery to the original shape) results in pressure fluctuations within the habitat, which can lead to false alarms and, in extreme cases, a loss of containment.

Accordingly, by monitoring of the static overpressure alone, it is not possible to determine whether a measured overpressure is representative of a hazardous habitat condition. In some circumstances this may lead to false alarms, and in other circumstances potentially dangerous operating conditions are undetected.

The prior art does not address the problem of wind on a habitat relating to control system. It is an object of the present invention to avoid or minimise the aforementioned problem.

### SUMMARY OF THE INVENTION

According to a first aspect of the invention, there is provided a control system for use with a hot work habitat in which an overpressure is established comprising: a shutdown module for stopping the operation of apparatus for performing hot work within the habitat responsive to a received alarm signal, in use of the control system; pressure sensing apparatus for measurement of static pressure difference between the interior of a habitat and external to a habitat; at least one air speed sensor for measurement of air speed outside of a habitat, and; a pressure differential module formed and arranged to receive data (preferably real-time data) from the pressure sensing apparatus and the at least one air speed sensor;

wherein the pressure differential module is operable to calculate a threshold air speed value above which the static pressure difference is less than a predetermined pressure difference, and configured to send an alarm signal to the shutdown module if an air speed value is detected above the threshold air speed value for a length of time longer than a predetermined time parameter.

The pressure sensing apparatus may be a pressure differential sensor (for example a pressure differential transducer). In some embodiments, the pressure sensing apparatus comprises at least one pressure sensor for placement inside the habitat to measure an internal pressure; and at least one pressure sensor for placement outside the habitat to measure an external pressure; to thereby measure the static pressure difference between the interior of a habitat and external to a habitat.

Preferably, the shutdown module shuts down the operation of apparatus performing hot work in the habitat upon reception of an alarm signal (such as an alarm signal sent by and received from the pressure differential module, and in some embodiments an alarm signal from one or more further sensors, where present).

The alarm signal may be sent to the shutdown module via a sensing module, the sensing module being connected to a plurality of sensors selected from a gas sensor/gas sensor system, a temperature sensor and a pressure sensor.

Preferably, the pressure differential module calculates the threshold air speed value as a square root of a pressure difference factor, the pressure difference factor being equal to two times the static pressure difference measured between the inside and the outside of the habitat divided by air density.

The pressure differential module may be operable to calculate the threshold air speed value above which the predetermined pressure difference that is greater than 0 Pa. The predetermined pressure difference may be equal to, or a proportion of, a target overpressure (by which is meant the minimum allowable pressure difference between the inside and the outside of the habitat, for safe working, and which may be determined on a case by case basis). The predetermined pressure difference may be a half, or a quarter, of the target overpressure. In some embodiments, the target overpressure is 50 Pa, and the predetermined pressure difference may be 50 Pa or less than 50 Pa, or zero. The predetermined pressure difference may be user programmable (and thus the pressure differential module may be user programmable so as to be operable to calculate a threshold air speed value based on a user-programmable predetermined pressure difference).

The pressure differential module may be formed and arranged to send the alarm signal to the shutdown module based on a value of the predetermined time parameter that is longer than 0 seconds (i.e. the alarm signal may be sent if an air speed value above the threshold air speed value is detected). The predetermined time parameter may be user programmable (and thus the pressure differential module may be user programmable so as to be operable to calculate a threshold air speed value based on a user-programmable predetermined time parameter). The predetermined time parameter may be between 0 seconds and 120 seconds, or 20 seconds and 90 seconds. In some embodiments, the predetermined time parameter is 30 seconds.

In some circumstances, a short gust of wind does not represent a safety hazard. A predetermined time parameter of, for example, 30 seconds, prevents the shutdown module from stopping the hot work apparatus responsive to a reading above the threshold air speed value lasting only a short period (for example, resulting from a short gust of wind) and so prevents unnecessary shutdown of hot work apparatus. However in other circumstances, it is preferred that hot work apparatus be stopped immediately on detection of air speed values above the threshold air speed value, and the predetermined time parameter is zero seconds.

The control system may comprise any suitable type of air speed sensor, for example an anemometer (such as a cup or windmill anemometer, or a hot wire, acoustic resonance or Doppler laser anemometer) a manometer or a Pitot tube. The air speed sensor may be an explosion proof, EX-marked, ATEX certified air speed sensor, or any other type of air speed sensor suitable for use in hazardous environments, such as Zone 1 or Zone 2 environments. The term “ATEX certified” refers to EC directives 94/9/EC or 99/92/EC.

The control system may comprise a central control unit, comprising the shutdown module and/or the pressure differential module. In some embodiments, the control system comprises a pressure differential unit comprising the pressure differential module. The control system may be portable, and may for example comprise a portable central control unit (and/or pressure differential unit, and/or shutdown unit, each said unit connectable to each other). The central control unit (where present) and/or the pressure differential unit may be operable to receive real-time data from the pressure sensing apparatus, the or each air speed sensor, and each said further sensor (where present). It will be understood that interconnected units or modules may be able to receive and/or relay and/or process data received from the said apparatus and sensors in various ways, so as to form a control system of the present invention.

According to a second aspect of the invention there is provided a hot work habitat system comprising: a habitat; apparatus for performing hot work within the habitat; an air supply system for providing air to the habitat so as to provide an overpressure of air within the habitat and; a control system of the first aspect, the control system comprising: a shutdown module for stopping the operation of apparatus for performing hot work within the habitat, responsive to a received alarm signal; pressure sensing apparatus operable to measure the static pressure difference between the interior of a habitat and external to the habitat; at least one air speed sensor placed outside the habitat to measure air speed; a pressure differential module formed and arranged to receive data (preferably real-time data) from the pressure sensing apparatus the at least one air speed sensor;

wherein the pressure differential module is operable to calculate a threshold air speed value above which the static pressure difference is less than a predetermined pressure difference and configured to send an alarm signal to the shutdown module in response to the detection of air speed above a threshold value for a length of time longer than a predetermined time parameter.

Preferably, the shutdown module shuts down the operation of apparatus performing hot work in the habitat upon reception of an alarm signal (such as an alarm signal from the pressure differential module, and in some embodiments an alarm signal from one or more further sensors, where present).

The habitat may be a flexible structure (i.e. formed from flexible materials), and may be made of panels connected and fastened together to form an enclosure (typically comprising walls, ceiling and floor). The habitat may be constructed around a framework, and for example may comprise a flexible enclosure supported by a framework. Typically, the habitat is a temporary structure, but may be a permanent structure within which hot work may be conducted.

According to a third aspect of the invention there is provided a method of controlling operation of apparatus for performing hot work within a habitat, the method comprising: monitoring the static pressure difference between the interior of the habitat and external to the habitat; and monitoring air speed outside the habitat; calculating a threshold air speed value, above which the static pressure difference is less than a predetermined pressure difference value; and stopping the operation of the apparatus if an air speed value above the threshold air speed value is detected for a length of time longer than a predetermined time parameter.

In some embodiments, the method comprises generating an alarm signal if the detected air speed value is above the threshold air speed value for a length of time longer than the predetermined time parameter (and may comprise sending the alarm signal to a shutdown module operable to stop the operation of the apparatus responsive to a received alarm signal).

The air speed may be monitored using an anemometer (which may be in communication, for example sending real time data to, a pressure differential module). The static pressure differential may be monitored using pressure sensing apparatus, such as one or more pressure sensors positioned inside and outside of the habitat, or a pressure differential sensor. The pressure sensing apparatus may be in communication with a pressure differential module.

The pressure differential module may be in communication with (and operable to send an alarm signal to) the shutdown module.

Preferably, the step of calculating the threshold air speed value involves evaluating a square root of a pressure difference factor, the pressure difference factor being equal to two times the static pressure difference measured between the inside and the outside of the habitat divided by air density.

Further preferred and optional features of the second and third aspects of the invention correspond to preferred and optional features of the first aspect of the invention.

### BRIEF DESCRIPTION OF THE DRAWINGS

Various aspects of the invention will now be described by way of example only and with reference to the accompanying drawings, of which:

FIG. 1a shows a schematic layout of the control system according to the invention.

FIG. 1b shows a schematic layout of an alternative embodiment of the control system of the invention.

FIG. 2 shows a schematic representation of a single security system controlling the operation of multiple individual habitats.

FIG. 3 shows the control system response to the detection of dangerous gas.

FIG. 4 shows the control system response to a drop of pressure measured inside the habitat, or an increase in air speed measured external to the habitat.

FIG. 5 shows a streamline flowing between the inside and the outside of the habitat through a leakage point.

FIG. 6 shows the critical operational condition function ΔP=0.5ρνₘₐₓ² corresponding to the minimum pressure differential ΔP required in order to maintain containment inside the habitat when a maximum air speed νₘₐₓ is measured outside the habitat.

### DETAILED DESCRIPTION OF THE INVENTION

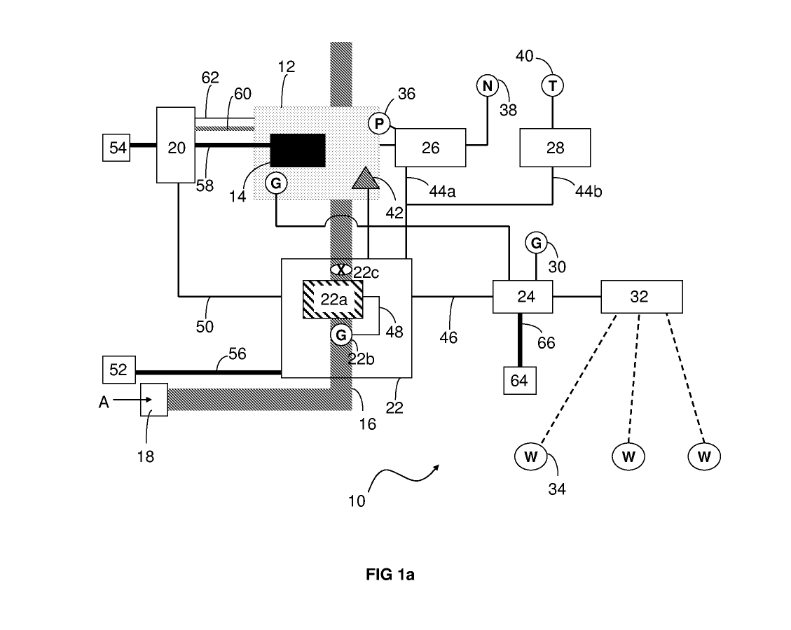

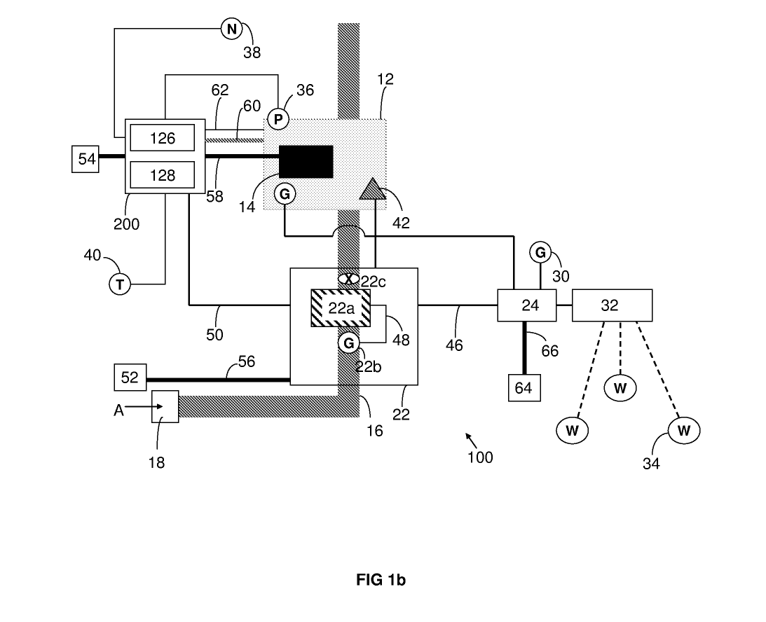

FIG. 1a shows a schematic layout of the welding control system 10 according to the invention. There is provided an enclosure (habitat) 12, in which apparatus 14 for undertaking hot work (such as welding, grinding or the like) is provided. The enclosure is a modular construction assembled from flexible panels which are secured together and provide an enclosed space for the hot work to be undertaken.

Air “A” is supplied to the enclosure so as to provide an overpressure of air in the enclosure and thereby prevent the ingress of inflammable gases which could be ignited by the hot work being undertaken. The air “A” is supplied into the enclosure through a duct 16 connected to an air inlet 18 located in an area where a “fresh” supply of air, free of any flammable gases, can be drawn from (typically away from where the enclosure is located).

The enclosure 12 is provided with a welding shutdown module 20 for controlling the shutdown of apparatus and equipment 14 inside the enclosure for performing hot work. The welding shutdown module 20 is connected to a gas sensing module 22 linked to a multi sensor module 24, a pressure differential unit 26 and a temperature sensor unit 28.

The gas sensing module 22 is provided with a ducted air shutoff system 22a activated via a butterfly valve (damper) 22c and a plurality of duct-mounted gas sensors 22b (only one sensor is shown in FIG. 1 for clarity) to detect the presence of hydrogen sulphide and methane. The gas sensing module is powered by a 110 or 240 Vac power supply 52 via flying lead cable 56. In addition, the module is formed and arranged to receive a plurality of alarm signals that include a pressure signal 44a from a pressure differential unit 26, a temperature signal 44b from a temperature sensing unit 28, an external gas signal 46 from a multi sensing module 24 and an air-supply gas signal 48 from the duct-mounted gas detector 22b.

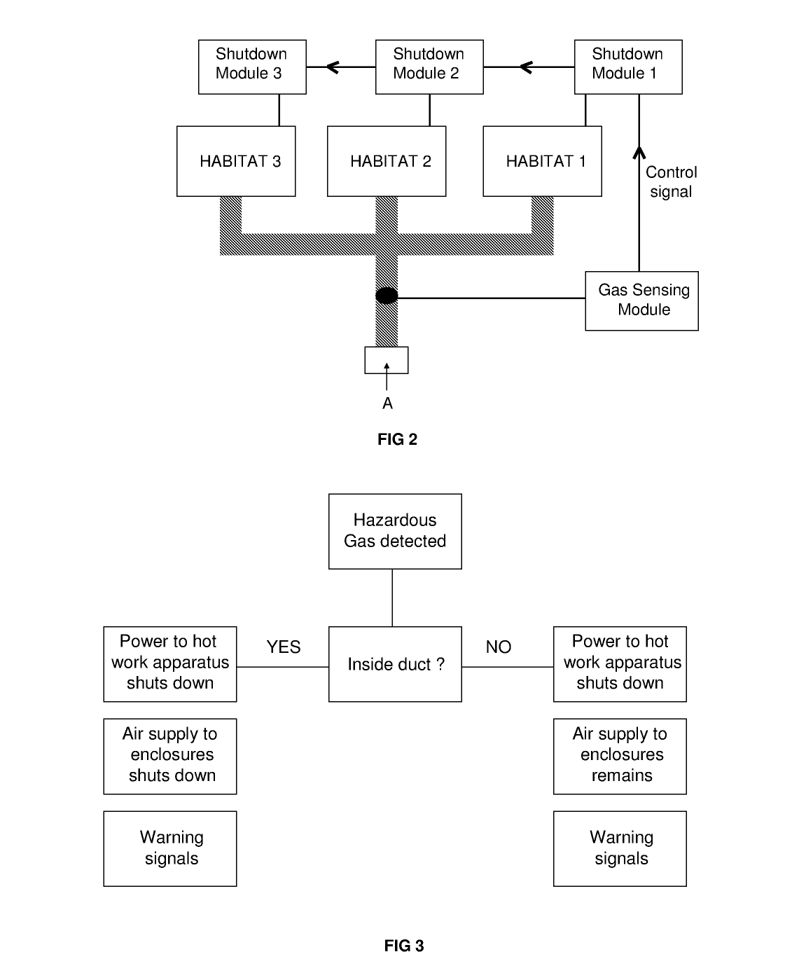

The welding shutdown module 20 is a relay switching and control unit. The module is arranged to receive a 24 Vdc control signal 50 from the gas sensing module 22 via an armoured cable lead which provide power to a 24 Vdc control relay. When energised, the control relay enables power to be distributed to four sockets, among which two are utilised for powering two apparatus for performing hot work 14. The welding shutdown module 20 is equipped with a control box mounted with indicator lamps showing the running or fault status of the two apparatus 14. The module is also provided with two gas lines 60, fitted with solenoid valve connections for supplying compressed air and oxy-acetylene to equipment in the habitat. In alternative embodiments, further solenoid valves may be provided to control the flow of gasses and/or liquids into the habitat, through further gas or liquid supply lines. The welding shutdown module is powered by its own individual power supply 54. The module is further mounted with a 24 Vdc output socket to transmit control signal 50 to another shutdown module. This enables the daisy-chaining of multiple welding shutdown modules, each controlled by a central gas sensing module in communication with pressure and air speed sensors (and typically also gas, oxygen and temperature sensors) relating to each of the habitats. Optionally, signals from external pressure or other sensors may be used to generate alarm signals relating to more than one of the multiple habitats. A schematic diagram of such a configuration is shown in FIG. 2.

The multi sensor module 24 is connected to four gas sensors 30 for the detection of flammable and toxic gas (only two sensors are shown in FIG. 1 for clarity, however in principle connection to any number of sensors is possible, for example via flying lead connections). All sensors are connected to a control box mounted with indicator lamps for each sensor input channel. The multi sensor module processes the signals from the four gas sensors and determines gas sensor status. If the gas sensor status is indicative of an alarm condition (for example if a single sensor reading is above a threshold level, or if a combination of sensor readings are above respective threshold levels), the multi sensor module relays an alarm signal to the gas sensing module 22 via signal 46. The module is powered by power supply 64 via 110 Vac flying lead 66. An additional control box is provided for the connection of a wireless gas sensor unit 32. A wireless gas sensor unit 32 related to a plurality of wireless gas sensors 34 is provided to monitor the presence of dangerous gas external to the enclosure.

The pressure differential unit 26 is linked to a differential pressure sensor that includes a pressure differential transducer 36 in communication with both the inside and the outside of the habitat, to measure the static pressure differential, and an air speed sensor 38, such as a 2D/3D anemometer, placed in a location that best represents the wind speed the habitat is experiencing. In an alternative embodiment (not shown), the pressure differential unit is connected to a pressure sensor placed inside the habitat and a pressure sensor placed outside of the habitat. The pressure differential unit is further connected to a socket on the gas sensing module and may also be powered by the gas sensing module. The pressure and air speed sensors are suitable for work in explosive atmosphere (and are typically ATEX certified, explosion proof and/or EX certified). The anemometer provides a direct reading of the dynamic pressure outside the habitat. The differential pressure sensor monitors the static pressure both inside and outside the habitat. These two readings are constantly monitored and compared to evaluate the habitats containment status. In the event of a loss of containment lasting longer than a predetermined length of time, an alarm signal is sent to the control system to shut down the equipment. The system can also implement proportional-integral-derivative control, time delays and minimum total pressure differential to prevent any spurious alarms and to ensure that the system operates within a reasonable safety margin.

The temperature sensing unit 28 can be connected to either the gas sensing module 22 or the welding shutdown module 20 and may be used as a replacement to the pressure differential unit 26 or be built into the pressure differential unit. The temperature sensing unit also contains at least one thermistor 40 to measure the temperature of work piece at exit points from the habitat. This ensures that temperatures exceeding the flashpoint of particular gases do not occur outside of the enclosure.

An alternative embodiment, of the invention control system 100, is shown in FIG. 1b, with the same reference numerals allocated to features in common to control system 10. Control system 100 comprises welding shutdown module 200. Welding shutdown module 200 is directly connected to thermistor 40, pressure differential sensor 36 and air speed sensor 38. Control system 100 comprises integral pressure differential module 126 and integral temperature sensor unit 128, which perform the same function as pressure differential unit 26 and temperature sensor unit 28, respectively, of control system 10. In further embodiments (not shown) the welding shutdown module is operable to receive data from sensors 36, 38, 40 and comprises software operable to function as a pressure differential module and/or a temperature sensor module.

In still further embodiments (not shown) the welding control module may comprise, or further comprise, integral gas sensing modules. Alternatively, the control system may comprise a multi sensor module (or a welding control module) in communication with one or more of the gas sensors 34, thermistor 40, pressure differential sensor 36 and air speed sensor 38; operable to function as a temperature control unit, pressure differential unit and/or gas sensor unit, so as to provide the control system as a whole with equivalent functionality to systems 10, 100.

### MODE OF OPERATION

In normal operation mode, the gas sensing module 22 sends an output signal 50 to the welding shutdown module 20 that maintains operation of the welding equipment. When a hazard is detected and communicated to the gas sensing module via at least one of alarm signals 44a, 44b, 46 or 48, the gas sensing module 22 stops sending the output signal 50, resulting in the shutdown of power to the welding equipment and welding control system tools sockets.

FIG. 3 shows the series of actions performed by the gas sensing module in the event of a detection of gas inside or outside of the habitat. The detection of hazardous levels of flammable or toxic gases in the conduit 16 by a duct-mounted detector 22b, causes the gas sensing module controller 22a to: a) close the supply of air into the pressurised enclosure 12 by shutting the flap valve 22c, b) shut off power to the welding shutdown module control relay by removing the 24 Vdc control signal 50, causing the immediate shutdown of any connected hot work apparatus 14 and c) activate audible and visual warnings.

When a hazardous level of gas is detected outside the habitat by one of the wired gas sensors 30 or wireless gas sensors 34, the information is relayed to the multi sensor module 24 and sent to the gas sensing module via signal 46. It causes the gas sensing module controller 22a to: a) keep the flap valve 22c open (provided that no such hazardous level of gas is present in the ducted air), thus maintaining the air supply into the welding enclosure in order to maintain a positive pressure differential over its surrounding area and prevent hazardous gas ingress, b) shut off power to the welding shutdown module control relay by removing the 24 Vdc control signal 50 to the welding shutdown module, causing the immediate shutdown of any connected hot work apparatus and c) activate audible and visual warnings.

The control systems 10, 100 are also equipped with a temperature sensor unit 28. If thermistor 40 measures a temperature which is within a safety margin of the lowest flashpoint of a predetermined explosive gas, the temperature sensing unit 28 sends alarm signal 44b to the welding shutdown module 20 via the gas sensing module 22 in order to shutdown power to the hot work apparatus. This ensures that the external temperature does not reach the explosive gas flashpoint. The temperature sensing unit can also be configured to work with heating bands to prevent them from causing a hazard if they move from their designated place. This is achieved by locating the thermistor 40 on the work piece, near the heating band. The temperature of the work piece is then monitored. If the temperature drops, the temperature sensing unit 28 sends and alarm signal to the gas sensing module in order to cut off power to the heating band. An audiovisual alarm is also activated.

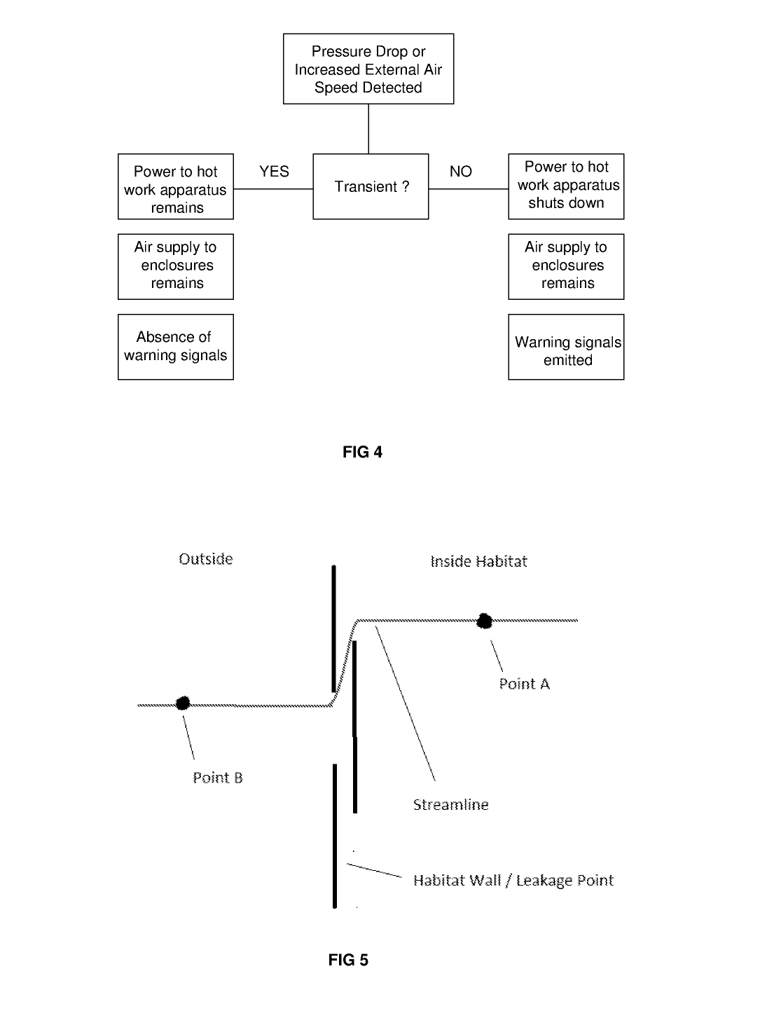

FIG. 4 shows the series of actions performed by the gas sensing module of systems 10, 100 in the event of a drop of pressure monitored inside the habitat, or an of the detection of an increase in air speed outside of the habitat above a threshold speed sufficient to overcome the overpressure of the habitat. The pressure difference between the inside and the outside of the habitat as well as the air speed outside the habitat are constantly monitored by sensors 36 and 38, linked to the pressure differential unit. If an air speed capable of overcoming overpressure is measured over a predetermined period of time, then the unit sends alarm signal 44a to the gas sensing module 22. This causes the gas sensing controller 22a to stop sending output signal 50 to the welding shutdown module 20, therefore stopping operation of the hot work apparatus. The damper 22c is kept open so as to maintain overpressure inside the habitat. Audible and visual warnings are activated.

The evaluation of an airspeed that can compromise containment, is based on Bernouilli's principle and test data. Correlation between air speed and pressure is governed by Bernoulli's principle which states that, in a steady flow, the sum of all forms of mechanical energy in a fluid along a streamline is the same at all points on that streamline. The total energy at a given point in a fluid is the energy associated with the movement of the fluid, plus energy from pressure in the fluid, plus energy from the height of the fluid relative to an arbitrary reference point. This principle can be expressed as the Bernoulli's equation: 0.5 ρν²+ρgz+P=cst, where the first term is the dynamic pressure, the second term the hydraulic head and the third term the static pressure. The parameter ν is the velocity of flow at a point in the streamline, P the static pressure at that point, g the acceleration due to gravity, z the vertical distance above a reference plane, and ρ the fluid density.

Bernouilli's equation can be applied to an air flow exiting the habitat through a leakage point. FIG. 5 describes the path that offers the least resistance to air flow. This path also referred to as streamline, shows the direction air will travel in at any point in time. As the change in height along the streamline is small, the change in hydraulic head between points A and B is negligible. Bernouilli's principle can therefore be applied in its simplified form as: 0.5 ρν_{A}²+P_{A}=0.5 ρν_{B}²+P_{B} where the total pressure is the same at all points on the streamline. The air speed at Point A inside the habitat can be considered to be 0 m/s. In order for the habitat to maintain containment, the static pressure at point A must therefore be greater than the sum of the static pressure at point B and the dynamic pressure at point B. This can be expressed as: P_{A}>0.5 ρν_{B}²+P_{B}. The direction of propagation of air along the streamline varies depending on the internal static pressure, the external static pressure and the external wind speed (dynamic pressure). Checking the habitat containment status requires the continuous monitoring of these three parameters.

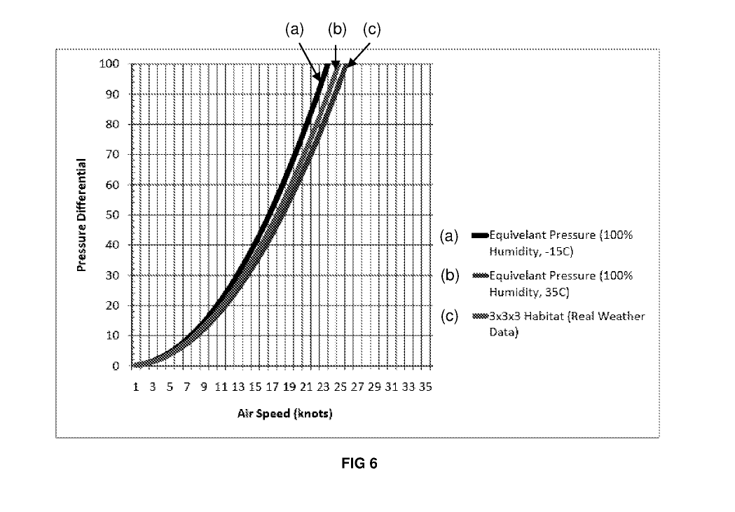

FIG. 6 shows the critical operational condition function ΔP=0.5 ρνₘₐₓ² corresponding to the minimum pressure differential ΔP required in order to maintain containment inside the habitat for a maximum, threshold air speed νₘₐₓ, measured outside the habitat. The different curves correspond to operational overpressure ΔP calculated for different pressures and temperatures conditions. From FIG. 6 it can be deduced that at an operational overpressure of 50 Pa, a wind speed over a threshold of 16 knots could potentially compromise containment.

An advantage of the use of the enclosure control system according to the invention is that short lived, transient loss of containment, are identified without triggering unnecessary shutdown of the apparatus for performing hot work within the enclosure. The control system allows the shutdown of the apparatus to be performed only in the necessary cases when containment is lost over a period of time sufficiently long to compromise the safety of the work carried inside the habitat. As a result, operation of the hot work apparatus is managed more efficiently, allowing maximization of working time.

A skilled person will appreciate that variations of the disclosed arrangements are possible without departing from the invention. For example, air speed measurement could be enhanced by using more than one anemometer, each positioned in different locations around the habitat. Accordingly, the above description of the specific embodiment is made by way of example only and not for the purposes of limitation. It will be clear to the skilled person that minor modifications may be made without significant changes to the operation described.

1. A control system for use with a hot work habitat in which an overpressure is established comprising:
a shutdown module for stopping the operation of apparatus for performing hot work within the habitat responsive to a received alarm signal, in use of the control system;
pressure sensing apparatus for measurement of the static pressure difference between the interior of a habitat and external to a habitat;
at least one air speed sensor for measurement of air speed outside of a habitat, and;
a pressure differential module formed and arranged to receive data from the pressure sensing apparatus and the at least one air speed sensor;
wherein the pressure differential module is operable to calculate a threshold air speed value above which the static pressure difference is less than a predetermined pressure difference, and is configured to send an alarm signal to the shutdown module if an air speed value is detected above the threshold air speed value for a length of time longer than a predetermined time parameter.

2. A system as claimed in claim 1, wherein the alarm signal is sent to the shutdown module via a sensing module, the sensing module being connected to a plurality of sensors selected from a gas sensor/gas sensor system, a temperature sensor and a pressure sensor.

3. A system as claimed in claim 1, wherein the pressure differential module is formed and arranged to calculate the threshold air speed value as a square root of a pressure difference factor, the pressure difference factor being equal to two times the static pressure difference.

4. A system as claimed in claim 1, wherein the predetermined pressure difference is equal to or a proportion of a target overpressure.

5. A system as claimed in claim 1, wherein the predetermined pressure difference is 0 Pa.

6. A system as claimed any one preceding claim 1, wherein the predetermined time parameter is 0 seconds.

7. A hot work habitat system comprising:
a habitat;
apparatus for performing hot work within the habitat;
an air supply system for providing air to the habitat so as to provide an overpressure of air within the habitat and;
a control system comprising:
a shutdown module for stopping the operation of apparatus for performing hot work within the habitat, responsive to a received alarm signal;
pressure sensing apparatus operable to measure the static pressure difference between the interior of a habitat and external to the habitat; at least one air speed sensor placed outside the habitat to measure air speed,
a pressure differential module formed and arranged to receive data from the pressure sensing apparatus the at least one air speed sensor;
wherein the pressure differential module is operable to calculate a threshold air speed value above which the static pressure difference is less than a predetermined pressure difference and configured to send an alarm signal to the shutdown module in response of the detection of air speed above a threshold value for a length of time longer than a predetermined time parameter.

8. A system as claimed in claim 7, wherein the enclosure is a flexible structure made of panels connected and fastened together to form an enclosure.

9. A method of controlling operation of apparatus for performing hot work within a habitat, the method comprising:
monitoring the static pressure difference between the interior of the habitat and external to the habitat; and monitoring air speed outside the habitat;
calculating a threshold air speed value, above which the static pressure difference is less than a predetermined pressure difference value;
and stopping the operation of the apparatus if an air speed value above the threshold air speed value is detected for a length of time longer than a predetermined time parameter.

10. A method as claimed in claim 9, wherein the step of calculating the threshold air speed value involves evaluating a square root of a pressure difference factor, the pressure difference factor being equal to two times the static pressure difference.
